(19) United States
(12) Patent Application Publication
(10) Pub. No.: US 2002/0085343 A1
(43) Pub. Date: Jul. 4, 2002

(54) Modular portable computer with detachable main board module

(75) Inventors: Yu-Ho Wu, Tao-Yuan Hsien (TW); Chia-Chen Ho, Tao-Yuan Hsien (TW); Po-Wei Shih, Tao-Yuan Hsien (TW); Tai-Hung Lin, Tao-Yuan Hsien (TW)

Correspondence Address: BRINKS HOFER GILSON & LIONE, P.O. BOX 10395, CHICAGO, IL, 60610, US

(73) Assignee: Cirkitech Electronic Co., Ltd.

(21) Appl. No.: 09/832,702

(22) Filed: Apr. 11, 2001

(30) Foreign Application Priority Data
Jan. 2, 2001 (TW) 090200046
Jan. 2, 2001 (TW) 090200047
Jan. 2, 2001 (TW) 090200048

(51) Int. Cl. G06F 1/16

(52) U.S. Cl. 361/683

(57) ABSTRACT

A modular portable computer includes a housing, a signal transmission circuit board unit mounted in the housing, a power supply unit mounted on the housing and connected electrically to the circuit board unit, a display unit coupled pivotally to the housing and connected electrically to the circuit board unit, a keyboard module mounted on the housing and connected electrically to the circuit board unit, and a main board module which includes a casing unit mounted removably in the housing, and a processing unit, a memory module and a data storage medium that are mounted in the casing unit. The main board module further includes a connector unit for connecting electrically the main board module with the power supply unit, the display unit and the keyboard module via the circuit board unit when the main board module is disposed in the housing.

### BACKGROUND OF THE INVENTION

1. Field of the Invention

The invention relates to a portable computer, more particularly to a modular portable computer having a detachable main board module that can be connected to different input/output peripheral equipment according to the user's requirements.

2. Description of the Related Art

A conventional desktop computer has a relatively large size and is relatively heavy, and is thus inconvenient to carry outdoors. Portable computers, such as notebook computers, have grown in popularity in recent years in view of their smaller size and lighter weight, which make it possible to carry the same conveniently from one place to another. However, unlike desktop computers, it is very inconvenient and somewhat difficult to upgrade conventional notebook computers. In addition, it is not uncommon for some users to connect stand-alone computer monitors and computer keyboards to conventional notebook computers, especially when the computer monitors and computer keyboards that were originally built into the conventional notebook computers do not meet the user's size requirements.

### SUMMARY OF THE INVENTION

Therefore, the main object of the present invention is to provide a modular portable computer having a detachable main board module that can be upgraded with relative ease and that can be connected to different input/output peripheral equipment to suit the user's requirements.

According to the present invention, a modular portable computer includes a housing, a signal transmission circuit board unit mounted in the housing, a power supply unit mounted on the housing and connected electrically to the circuit board unit, a display unit coupled pivotally to the housing and connected electrically to the circuit board unit, a keyboard module mounted on the housing and connected electrically to the circuit board unit, and a main board module which includes a casing unit mounted removably in the housing, and a processing unit, a memory module and a data storage medium that are mounted in the casing unit. The main board module further includes a connector unit for connecting electrically the main board module with the power supply unit, the display unit and the keyboard module via the circuit board unit when the main board module is disposed in the housing.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of the preferred embodiment of a modular portable computer according to the present invention;

FIG. 2 is an exploded perspective view showing an upper housing part of a housing of the preferred embodiment;

FIG. 3 is an exploded perspective view showing a lower housing part of the housing of the preferred embodiment;

FIG. 4 is an exploded perspective view showing a keyboard module of the preferred embodiment;

FIG. 5 is an exploded perspective view showing a main board module of the preferred embodiment;

FIG. 6 is an exploded perspective view showing a base board unit of the main board module of FIG. 5;

FIG. 7 is an exploded perspective view showing an inner frame member of the main board module of FIG. 5;

FIG. 8 is an exploded perspective view showing a casing unit of the main board module of FIG. 5;

FIG. 9 is an assembled perspective view of the preferred embodiment; and

FIG. 10 is a rear perspective view of the preferred embodiment.

### DETAILED DESCRIPTION OF THE PREFERRED EMBODIMENT

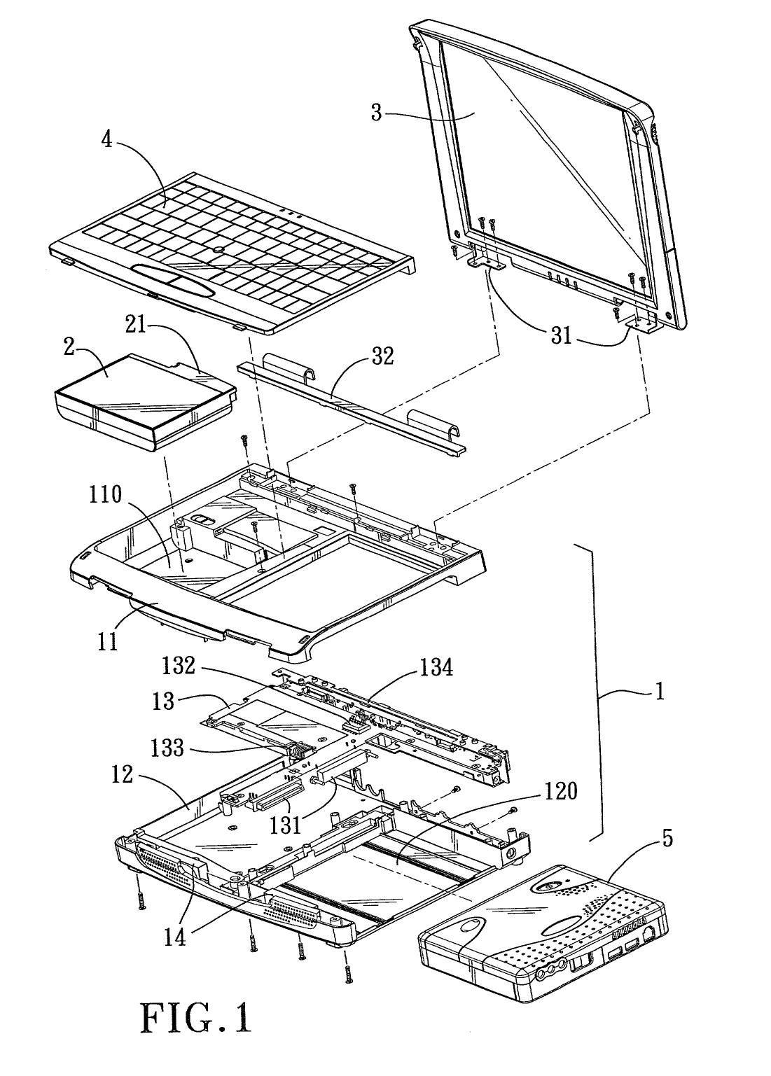

Referring to FIG. 1, the preferred embodiment of a modular portable computer according to the present invention is shown to comprising a housing 1, a power supply unit 2, a display unit 3, a keyboard module 4, and a detachable main board module 5.

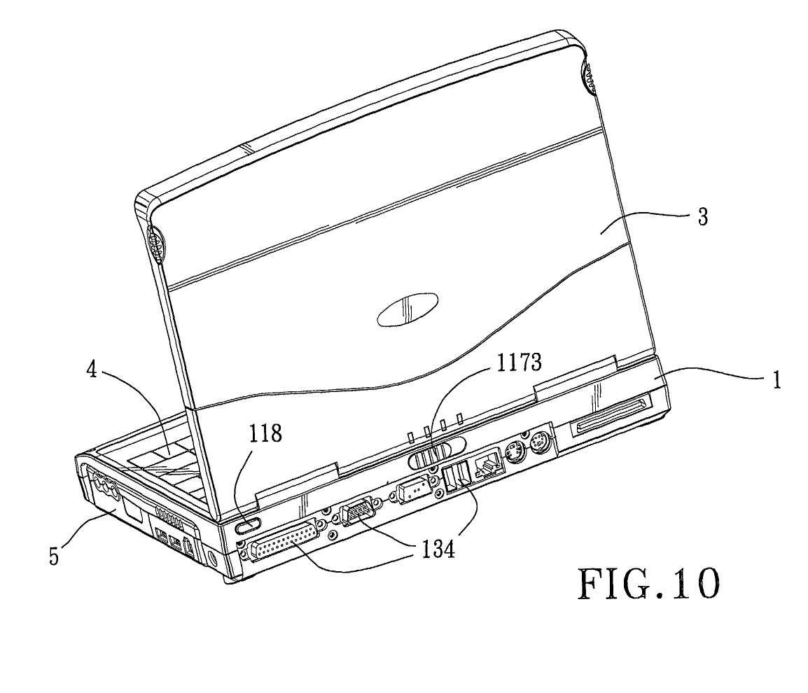

The housing 1 includes an upper housing part 11 and a lower housing part 12 that cooperate to form a receiving space therebetween. A signal transmission circuit board unit 13 is mounted in the receiving space, and is provided with a module connector set 131, a signal contact set 132, a power supply socket 133, and various signal connectors 134, such as a printer connection port, an RS232 communications port, a USB connection port, a PS/2 connection port, etc, which are connected to circuit traces on the circuit board unit 13 in a known manner. As best illustrated in FIG. 10, when the circuit board unit 13 is mounted in the housing 1, the housing 1 permits the various signal connectors 134 to be accessible externally of the housing 1 so as to permit connection of external peripheral equipment (not shown) thereto.

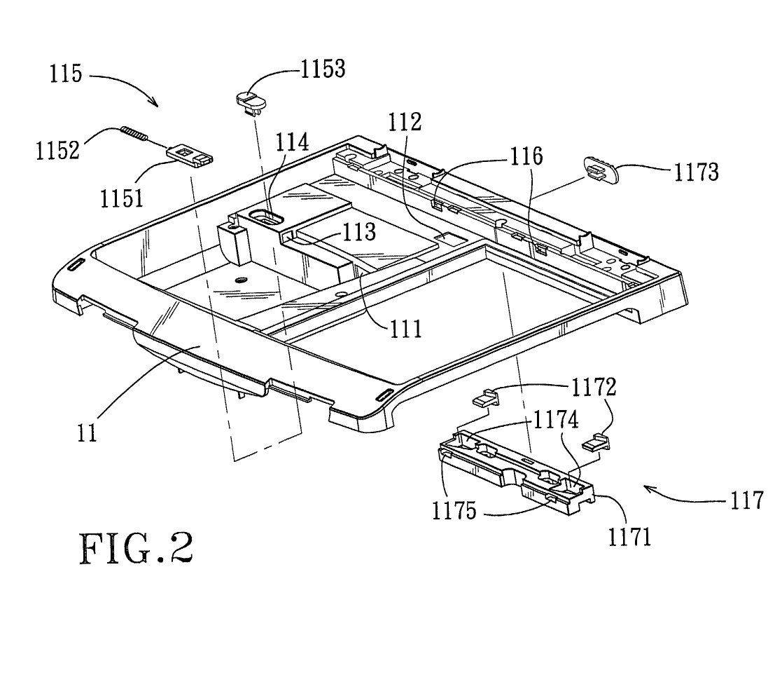

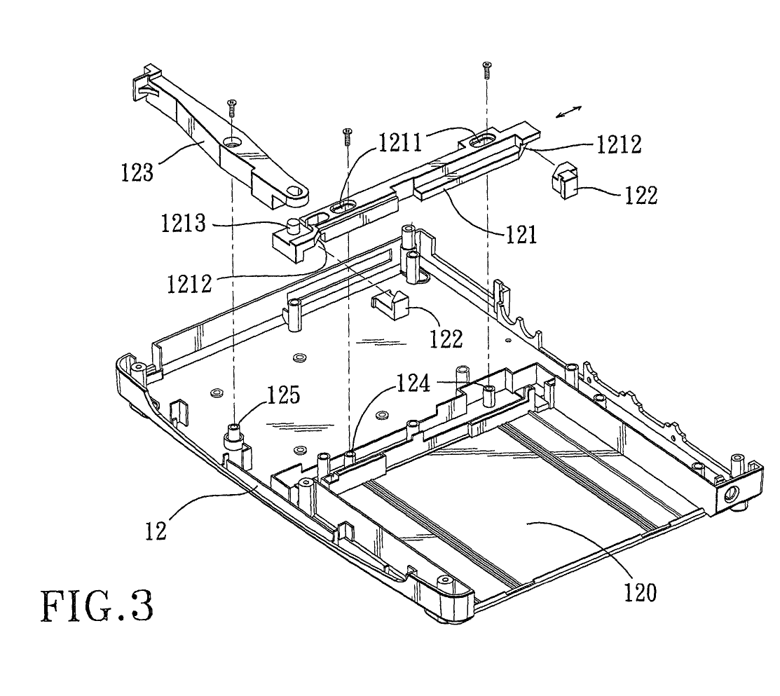

With reference to FIGS. 1 and 2, the upper housing part 11 is formed with a first receiving portion 110, a first opening 111 to permit the power supply socket 133 on the circuit board unit 13 to extend into the first receiving portion 110, and a second opening 112 to permit access to the signal contact set 132 on the circuit board unit 13. With reference to FIG. 3, the lower housing part 12 is configured with at least a second receiving portion 120.

Referring once again to FIG. 1, the power supply unit 2 is movably disposed in the first receiving portion 110 of the upper housing part 11, and is provided with a power plug 21 for connecting with the power supply socket 133 on the circuit board unit 13 so as to establish electrical connection between the power supply unit 2 and the circuit board unit 13. As shown in FIG. 2, the upper housing part 11 is further formed with a through hole 113 adjacent to the first receiving portion 110 and communicated with a channel 114 for receiving a first latch unit 115. The first latch unit 115 is used to retain releasably the power supply unit 2 (see FIG. 1) in the first receiving portion 120, and includes a latch plate 1151, a spring 1152 and a button 1153. The latch plate 1151, which is disposed in the channel 114, is biased by the spring 1152 to a retaining position such that an engaging end of the latch plate 1151 extends through the through hole 113. The power plug 21 of the power supply unit 2 is formed with a recess (not visible) for engaging the engaging end of the latch plate 1151, thereby retaining the power supply unit 2 in the first receiving portion 120. The button 1153 is coupled to the latch plate 1151, and is operable so as to move the latch plate 1151 from the retaining position to a releasing position, where the latch plate 1151 is retracted into the channel 114 so as to disengage the power plug 21 and permit removal of the power supply unit 2 from the first receiving portion 120.

The display unit 3 (see FIG. 1), such as a liquid crystal display module, is provided with a pair of pivot members 31 for coupling pivotally the display unit 3 on a rear end of the upper housing part 11 such that the display unit 3 is movable relative to the housing 1 between open and closed positions. The display unit 3 is connected electrically to the circuit board unit 113 via a ribbon cable (not shown). A cover plate 32 is mounted on the upper housing part 11 to conceal the pivot members 31.

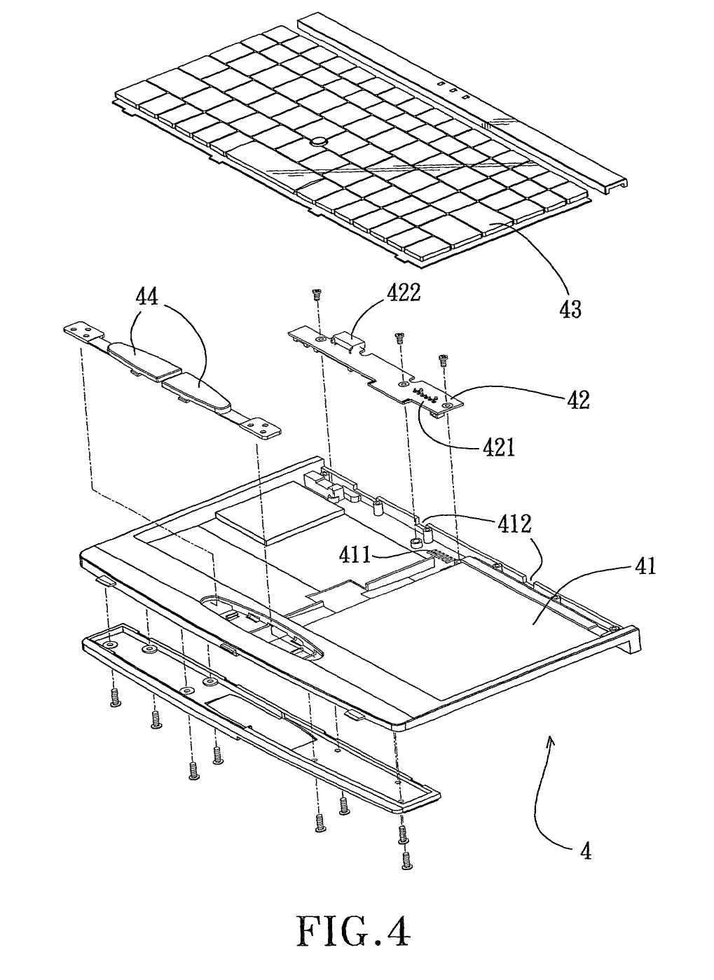

With reference to FIG. 4, the keyboard module 4 includes a base member 41, a keyboard connector circuit 42, and a keyboard unit 43. The keyboard connector circuit 42 is connected electrically to the keyboard unit 43, and has a bottom side provided with a signal contact set 421, and an edge portion provided with a signal connector 422. The keyboard unit 43 is disposed on top of the base member 41, with the keyboard connector circuit 42 disposed between the base member 41 and the keyboard unit 43. The base member 41 is formed with a set of holes 411 that permit the signal contact set 421 to extend therethrough. As such, with reference to FIG. 1, the keyboard module 4 can be removably disposed on the upper housing part 11, and electrical connection can be established between the circuit board unit 13 and the keyboard module 4 via the signal contact sets 132, 421. When the keyboard module 4 is detached from the upper housing part 11, the signal connector 422 permits connection of the keyboard module 4 to an external electronic device, such as a desktop computer (not shown), so as to serve as a user input device for the latter. Preferably, the base member 41 further has cursor control keys 44 mounted operably thereon.

Referring back to FIG. 2, the upper housing part 11 is further formed with a pair of through holes 116 that are intercommunicated by a channel (not visible) for receiving a second latch unit 117. The second latch unit 117 is used to retain releasably the keyboard module 4 (see FIG. 1) on the upper housing part 11, and includes a slide block 1171, a pair of movable latch members 1172, and a button 1173. The slide block 1171 is formed with a pair of vertical holes 1174, each of which is defined by an inclined guide surface, and is communicated with a respective horizontal hole 1175. Each of the latch members 1172 is received in a respective one of the vertical holes 1174, and has a tapered portion in sliding contact with the inclined guide surface of the respective vertical hole 1174, and a projecting portion that extends through the respective horizontal hole 1175. The slide block 1171 and the latch members 1172 are disposed in the upper housing part 11 such that the projecting portions of the latch members 1172 extend through the through holes 116 when the second latch unit 117 is in a retaining state. With further reference to FIG. 4, the base member 41 of the keyboard module 4 is formed with a pair of latch grooves 412 for engaging the projecting portions of the latch members 1172 when the second latch unit 117 is in the retaining state, thereby retaining the keyboard module 4 on the upper housing part 11. The button 1173 is disposed at an outer surface of the upper housing part 11, as best shown in FIG. 11, and is coupled to the slide block 1171. The button 1173 is operable so as to move the slide block 1171. Since the tapered portions of the latch members 1172 are in sliding contact with the inclined guide surfaces of the vertical holes 1174, movement of the slide block 1171 can result in retraction of the projecting portions of the latch members 1172 into the through holes 116 so as to dispose the second latch unit 117 in a releasing state, where the latch members 1172 cease to engage the base member 41 of the keyboard module 4 and permit removal of the keyboard module 4 from the upper housing part 11.

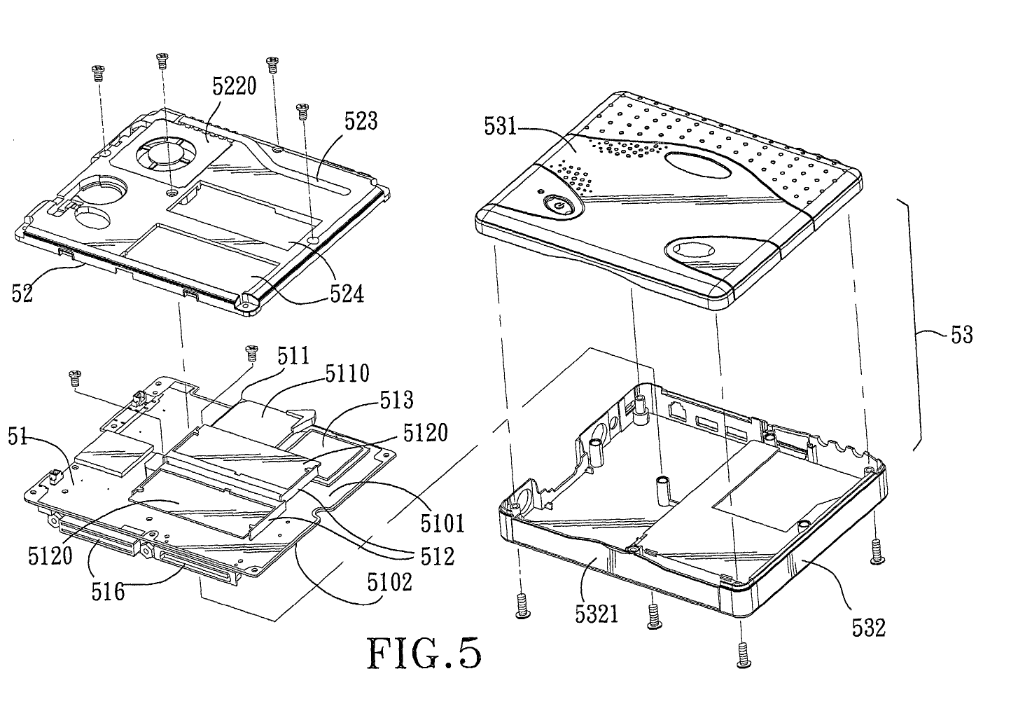

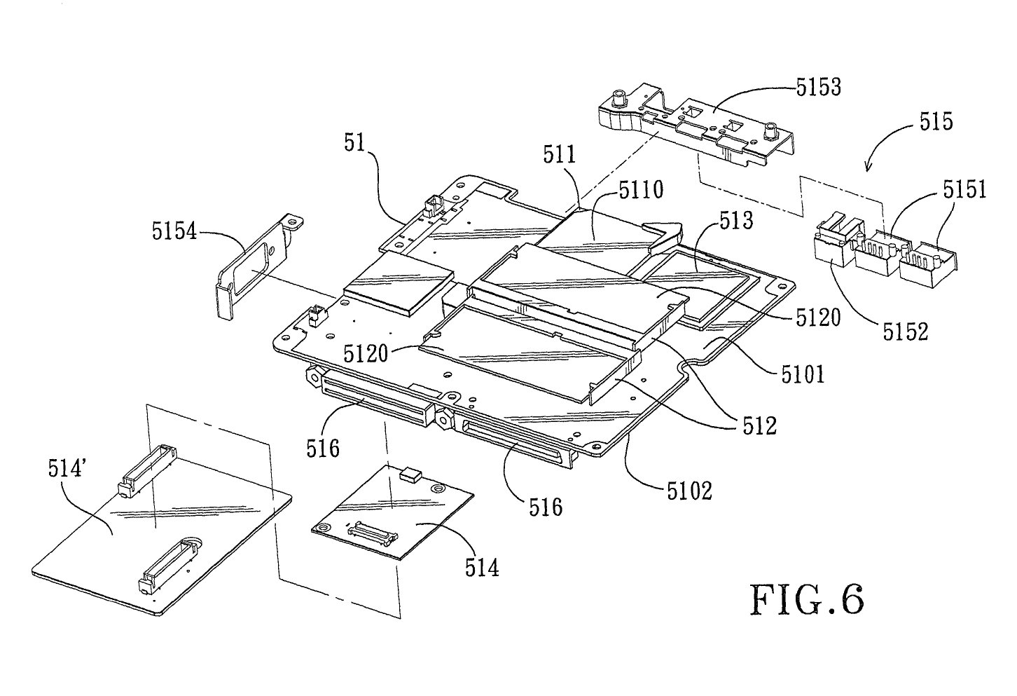

Referring to FIGS. 1 and 5, the main board module 5 is disposed removably in the second receiving portion 120 of the lower housing part 12, and includes a base board unit 51, an inner frame member 52 and a casing unit 53. With further reference to FIG. 6, the base board unit 51 has a first printed circuit surface 5101, and a second printed circuit surface 5102 opposite to the first printed circuit surface 5101. The first printed circuit surface 5101 has a processor socket 511 and a pair of memory sockets 512 mounted thereon and connected electrically thereto. A processing unit 5110 is mounted removably on and is connected electrically to the processor socket 511. Each of a pair of memory modules 5120 is mounted removably on and is connected electrically to a respective one of the memory sockets 512. Preferably, the memory sockets 512 open in opposite directions and permit the memory modules 5120 to lie parallel to the first printed circuit surface 5101 so as not to introduce a substantial increase in the thickness of the main board module 5 when the memory modules 5120 are mounted on the memory sockets 512. In addition, an audio-video chipset 513, which incorporates the functions of a display card and a sound card, is mounted on the first printed circuit surface 5101 adjacent to the processor socket 511, and is in electrical connection with the first printed circuit surface 5101.

To further enhance the functionality of the baseboard unit 51, a first daughter circuit board 514, such as a modem card, is mounted removably on the second printed circuit surface 5102 such that the first daughter circuit board 514 lies parallel to the second printed circuit surface 5102 and is connected electrically thereto. A second daughter circuit board 514′, such as a power controller card, can be similarly mounted on and connected electrically to the second printed circuit surface 5102 such that the first and second daughter circuit boards 514, 514′ are in a stacked arrangement to result in a compact structure. Preferably, a sponge layer (not shown) is disposed between the first and second daughter circuit boards 514, 514′ to prevent short-circuiting therebetween.

In addition, the main board module 5 further has a connector unit which includes a signal input/output connector set 515 and a module connector set 516 that are mounted on the base board unit 51 and that are connected electrically to at least one of the first and second printed circuit surfaces 5101, 5102. The signal input/output connector set 515, which corresponds to the signal connectors 134 on the circuit board unit 13, can include a VGA connector for a computer monitor, a USB connector, an RJ11 signal connector, a loudspeaker jack, a microphone input jack, an external audio input jack, a power source connector, and a data transmission socket. The module connector sets 516, 131 enable electrical connection between the base board unit 51 and the circuit board unit 13 when the main board module 5 is disposed in the second receiving portion 120. In the preferred embodiment, the signal input/output connector set 515 includes two USB connectors 5151 and an RJ11 signal connector 5152 that are mounted on a connector frame 5153, which in turn, is secured to an edge portion of the base board unit 51. A VGA connector frame 5154 is secured on another edge portion of the base board unit 51 for mounting a VGA connector (not shown) thereon.

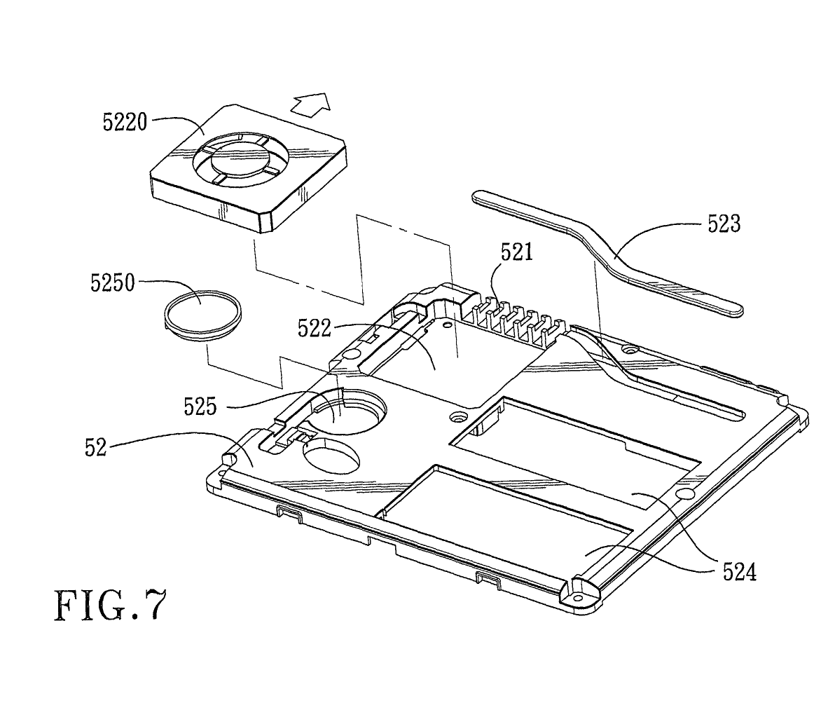

Referring to FIGS. 5 and 7, the inner frame member 52 is superimposed on the first printed circuit surface 5101 of the base board unit 51, and includes a heat-dissipating portion 521, a fan-mounting cavity 522, a heat-dissipating fan 5220, and a heat-conducting pipe 523. The heat-dissipating portion 521, in the form a heat sink, is adapted to dissipate heat to the atmosphere. The heat-dissipating fan 5220 is mounted in the fan-mounting cavity 522. The heat-conducting pipe 523 has one end disposed to contact the processing unit 5110 and the audio-video chipset 513, and an opposite end disposed to connect with the heat-dissipating portion 521 so as to transmit heat generated by the processing unit 5110 and the audio-video chipset 513 to the heat-dissipating portion 521. The heat-dissipating fan 5220 is connected electrically to the base board unit 51 and is operable so as to blow cooling air toward the heat-dissipating portion 521 and dissipate heat generated by the processing unit 5110 and the audio-video chipset 513. The inner frame member 52 is further formed with a pair of access holes 524 that are registered with the memory modules 5120 on the base board unit 51, thereby permitting installation and replacement of the memory modules 5120 without disassembling the inner frame member 52. The inner frame member 52 is further formed with a loudspeaker-receiving cavity 525, and has a loudspeaker 5250 mounted in the loudspeaker-receiving cavity 525 and connected electrically to the base board unit 51 for sound reproduction purposes.

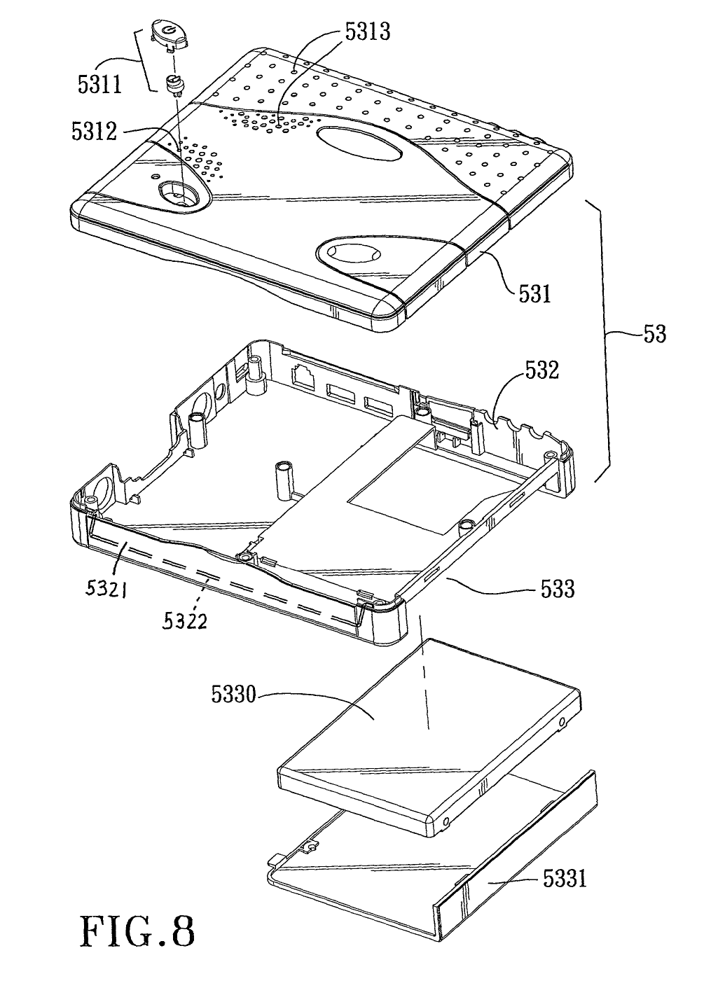

With reference to FIG. 8, the casing unit 53 includes an upper casing part 531 and a lower casing part 532 that is connected removably to the upper casing part 531. The casing parts 531, 532 cooperate to confine a compartment that receives assembly of the base board unit 51, the inner frame member 52, and the various components on the base board unit 51 and the inner frame member 52. The casing unit 53 permits the signal input/output connector set 515 to be accessible externally thereof so as to permit connection of external peripheral equipment (not shown) to the signal input/output connector set 515 when the mainboard module 5 is detached from the second receiving portion 120. A power switch 5311 is mounted on the upper casing part 531, and is connected electrically to the base board unit 51 for controlling the supply of electric power to the base board unit 51. The upper casing part 531 is further formed with a plurality of sound holes 5312 that are aligned with the loudspeaker 5250 on the inner frame member 52 such that sound generated by the loudspeaker 5250 can be audibly transmitted to the exterior of the casing unit 53. The upper casing part 531 further has a plurality of vent holes 5313 that are aligned with at least one of the heat-dissipating fan 5220 and the heat-conducting pipe 523 for introducing cooling air into the casing unit 53. The lower casing part 532 has one side formed with a receiving space 533 for receiving a data storage medium 5330, such as a hard disk drive, that is to be connected electrically to the base board unit 51. A cover 5331 is mounted on the lower casing part 532 to close the receiving space 533.

The lower casing part 532 further has a spring-biased pivotable wall portion 5321 disposed adjacent to the module connector set 516 (see FIG. 6). The wall portion 5321 is biased by a spring member 5322 to a normally closed position for concealing the module connector set 516 when the main board module 5 is removed from the second receiving portion 120. When the main board module 5 is disposed in the second receiving portion 120, the module connector set 131 (see FIG. 1) on the circuit board unit 13 will move the wall portion 5321 to an open position against the action of the spring member 5322 so as to permit connection between the module connector sets 131, 516, thereby establishing electrical connection between the circuit board unit 13 and the main board module 5.

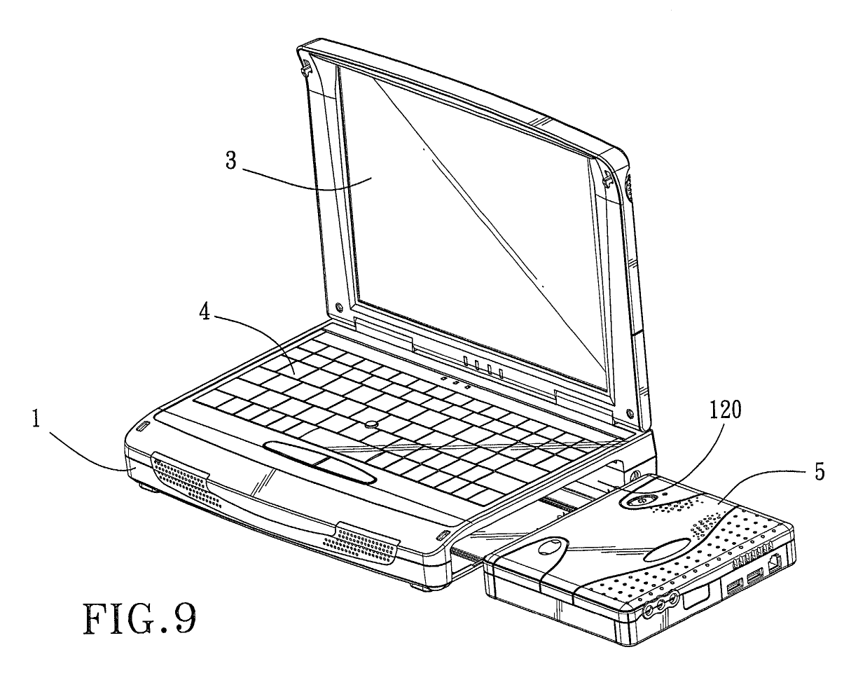

Referring back to FIG. 3, a pair of positioning posts 124 are disposed on the lower housing part 12 adjacent to an innermost end of the second receiving portion 120 relative to an inserting direction of the main board module 5. The lower housing part 12 is further formed with a pivot shaft 125. A slide rod 121 is formed with a pair of elongated slots 1211 that respectively permit extension of the positioning posts 124 therein, thereby permitting limited movement of the slide rod 121 in the lower housing part 12. The slide rod 121 has opposite end portions, each of which is formed with a bevel face 1212 for engaging a respective one of a pair of push members 122. As such, movement of the slide rod 121 results in corresponding movement of the push members 122 in the second receiving portion 120 along the inserting direction of the main board module 5. The slide rod 121 is further formed with a pivot shaft 1213. An actuating rod 123 has one end coupled to the pivot shaft 1213, an intermediate portion coupled to the pivot shaft 125, and an opposite end that extends out of the lower housing part 12. When the opposite end of the actuating rod 123 is operated, the actuating rod 123 pivots about the pivot shaft 125 and causes the slide rod 121 to move in the lower housing part 12. Thus, when the main board module 5 is inserted into the second receiving portion 120 (see FIG. 9) to inter-engage the module connector sets 516, 131 in the manner described beforehand, the main board module 5 presses against the push members 122 such that the slide rod 121 is disposed in a non-ejecting position. When the opposite end of the actuating rod 123 is operated to move the slide rod 121 to an ejecting position in the lower housing part 12, corresponding movement of the push members 122 along the inserting direction of the main board module 5 results, thereby pushing the main board module 5 so as to disengage the module connector sets 516, 131 from each other and so as to move the main board module 5 out of the second receiving portion 120.

Referring again to FIG. 1, to further enhance functionality of the modular portable computer of this invention, a pair of loudspeakers 14 can be mounted on the lower housing part 12 and can be connected electrically to the circuit board unit 13 for sound reproduction purposes. As shown in FIG. 10, a power switch 118 is mounted on the housing 1, and is connected electrically to the circuit board unit 13 for controlling the supply of electric power to the circuit board unit 13.

When the main board module 5 is detached from the housing 1, it can be conveniently connected to standard peripheral equipment, such as a computer monitor, a computer keyboard, a computer printer, etc., according to the user's requirements. In addition, when the keyboard module 4 is detached from the housing 1, it can be connected to an external electronic device, such as a desktop computer, so as to serve as a user input device for the latter. Moreover, as compared to a conventional notebook computer, installation and replacement of the processing unit 5110 and the memory modules 5120 in the main board module 5 for upgrading the modular portable computer of this invention can be conducted with relative ease.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A modular portable computer, comprising:
a housing;
a signal transmission circuit board unit mounted in said housing;
a power supply unit mounted on said housing and connected electrically to said circuit board unit;
a display unit coupled pivotally to said housing and connected electrically to said circuit board unit;
a keyboard module mounted on said housing and connected electrically to said circuit board unit; and
a main board module including a casing unit mounted removably in said housing, and a processing unit, a memory module and a data storage medium that are mounted in said casing unit, said main board module further including a connector unit for connecting electrically said main board module with said power supply unit, said display unit and said keyboard module via said circuit board unit when said main board module is disposed in said housing.

2. The modular portable computer of claim 1, wherein said power supply unit is mounted removably on said housing, said housing being provided with a latch unit for retaining releasably said power supply unit on said housing.

3. The modular portable computer of claim 1, wherein said keyboard module is mounted removably on said housing and is provided with a signal connector that is adapted to permit electrical connection between said keyboard module and an external electronic device when said keyboard module is removed from said housing.

4. The modular portable computer of claim 1, wherein said keyboard module is mounted removably on said housing, said circuit board unit being provided with a first signal contact set, said keyboard module being provided with a second signal contact set for contacting said first signal contact set so as to establish electrical connection between said keyboard module and said circuit board unit when said keyboard module is mounted on said housing.

5. The modular portable computer of claim 1, wherein said keyboard module is mounted removably on said housing, said housing being provided with a latch unit for retaining releasably said keyboard module on said housing.

6. The modular portable computer of claim 1, wherein said main board module further includes:
a base board unit connected electrically to said data storage medium in said casing unit and having a first printed circuit surface and a second printed circuit surface opposite to said first printed circuit surface, said first printed circuit surface having a processor socket and a memory socket mounted thereon and connected electrically thereto, said processing unit being mounted removably on and being connected electrically to said processor socket, said memory module being mounted removably on and being connected electrically to said memory socket, said connector unit including a module connector set and a signal input/output connector set that are connected electrically to at least one of said first and second printed circuit surfaces; and
an inner frame member superimposed on said first printed circuit surface of said base board unit, said inner frame member including a heat-dissipating portion, a fan-mounting cavity, a heat-dissipating fan mounted in said fan-mounting cavity, and a heat-conducting pipe having one end disposed to contact said processing unit and an opposite end connected to said heat-dissipating portion so as to transmit heat generated by said processing unit to said heat-dissipating portion, said heat-dissipating fan being operable so as to blow cooling air toward said heat-dissipating portion;
said casing unit confining a compartment that receives assembly of said base board unit and said inner frame member therein, said casing unit permitting said module connector set to connect electrically and removably with said circuit board unit when said main board module is disposed in said housing, said casing unit permitting said signal input/output connector set to be accessible externally thereof so as to permit connection of external peripheral equipment to said signal input/output connector set when said main board module is detached from said housing.

7. The modular portable computer of claim 6, wherein said base board unit further includes a daughter circuit board mounted removably on and connected electrically to one of said first and second printed circuit surfaces.

8. The modular portable computer of claim 7, wherein said daughter circuit board lies parallel to said one of said first and second printed circuit surfaces.

9. The modular portable computer of claim 6, wherein said memory module lies parallel to said first printed circuit surface when mounted on said memory socket.

10. The modular portable computer of claim 6, wherein said inner frame member is formed with an access hole to permit installation and removal of said memory module on and from said memory socket via said inner frame member.

11. The modular portable computer of claim 6, wherein said casing unit has a power switch mounted thereon and connected electrically to said base board unit for controlling supply of electric power to said base board unit.

12. The modular portable computer of claim 6, wherein said inner frame member further has a loudspeaker-receiving cavity, and a loudspeaker mounted in said loudspeaker-receiving cavity and connected electrically to said base board unit.

13. The modular portable computer of claim 6, wherein said casing unit has a spring-biased pivotable wall portion disposed adjacent to said module connector set, said wall portion concealing said module connector set when said main board module is detached from said housing, said wall portion being moved by said circuit board unit to an open position to permit connection between said circuit board unit and said module connector set when said main board module is disposed in said housing.

14. The modular portable computer of claim 1, wherein said casing unit is formed with a receiving portion for receiving said main board module removably therein, said casing unit further having an ejecting device that is operable so as to push said main board module to move out of said receiving portion.

15. The modular portable computer of claim 1, wherein said display unit is a liquid crystal display module.

16. The modular portable computer of claim 1, wherein said data storage medium includes a hard disk drive.

17. The modular portable computer of claim 1, further comprising a loudspeaker unit mounted on said housing and connected electrically to said circuit board unit.
